(19) United States
(12) Patent Application Publication
(10) Pub. No.: US 2015/0313197 A1
(43) Pub. Date: Nov. 5, 2015

(54) AN ACCESSORY TO A FISHHOOK

(71) Applicant: Stephen Andrew LEIGH, Johannesburg (ZA)

(72) Inventor: Stephen Andrew LEIGH, Johannesburg (ZA)

(21) Appl. No.: 14/649,966

(22) PCT Filed: Dec. 6, 2013
(86) PCT No.: PCT/ZA2013/000096

§ 371 Date: Jun. 5, 2015

(30) Foreign Application Priority Data
Dec. 7, 2012 (ZA) 2012/9286

(51) Int. Cl. A01K 91/04; A01K 91/06; A01K 97/00; A01K 83/00

(52) U.S. Cl. CPC A01K 91/04; A01K 83/00; A01K 91/06; A01K 97/00

(57) ABSTRACT

The invention relates to an accessory to a fishhook that includes a positioning means (12) to be mounted on an eyelet (14) of a fishhook, a connecting means (18) extending from the positioning means (12) and attachment means (22) allowing objects to be attached thereto.

### TECHNICAL FIELD OF THE INVENTION

This invention relates to an accessory to a fishhook, specifically an accessory which allows objects to be attached to the fishhook.

### BACKGROUND TO THE INVENTION

The inventor is aware that in the art of fishing it is often advantageous to attach a secondary hook or a series of hooks, in addition to a primary fishhook. Furthermore, it is sometimes necessary to attach fishing line, wire or other secondary objects used for fishing to a fishhook. These attachments may however reduce the integrity and strength of the primary fishhook and it may also be difficult to secure them in a selected position.

It is an object of the invention to provide an accessory to a fishhook providing the fishhook with attachment means which overcomes the difficulties described above.

### GENERAL DESCRIPTION OF THE INVENTION

According to the invention there is provided an accessory to a fishhook including a positioning means configured to be mounted on an eyelet of the fishhook, a connecting means extending from the positioning means which is configured, in use, to be arranged substantially adjacent a shank portion of the fishhook and an attachment means extending from an opposing end of the connecting means allowing objects to be attached thereto.

The positioning means may include an elongate first member extending from the connecting means and a retaining member extending from an opposing end of the elongate first member for retaining the elongate first member in a desired position relative to the eyelet in use.

The retaining member may be spring biased to aid retention of the retaining member in an operative retaining condition of generally triangular formation. It may also include a generally hook-shaped member arranged on a free end region thereof.

A holding means may be provided between the elongate first member of the positioning means and the connecting means to permit hooking engagement with the hook-shaped member, and further to facilitate retention of the eyelet of the fishhook in use. The holding means may be generally S-shaped consisting of two arcuate extensions.

An eyelet may be arranged on a junction between the elongate first member and the retaining member. An arm may also extend from this junction to allow objects to be attached thereto in use.

The connecting means may be of generally elongate form and the length thereof may conform generally with the shank portion of the fishhook. The connecting means may be shaped to define an eyelet or notch for engaging with and receiving the shank portion of the fishhook.

The attachment means may include an elongate first member extending from the connecting means and a retaining member extending from the opposing end of the elongate first member for retaining objects attached to an elbow defined by the elongate first member and the retaining member, The retaining member may be spring biased to aid retention thereof in an operative retaining condition. It may include a generally hook-shaped member arranged on a free end region thereof.

The generally hook-shaped member may be configured to engage with a shank portion or hook portion of the fishhook in use. It may also be configured to engage with the holding means.

A securing means may be provided between the elongate first member of the attachment means and the connecting means to permit hooking engagement with the hook-shaped member and to secure the attachment means on the shank portion opposite the hook portion in use. The securing means may be generally S-shaped consisting of two arcuate extensions.

According to a further aspect of the invention there is provided an accessory to a fishhook which includes:
first attachment means shaped to define a first retaining zone, which first attachment means is configured to receive and hold captive an arcuate hook portion of a fishhook; and
second attachment means shaped to define a second retaining zone, which second attachment means is configured to receive and retain items to be attached in use; and
an extension member configured to extend between and interconnect the first and second attachment means.

The accessory to a fishhook may comprise a single elongate member which may take the form of a single wire strand, with a first end of the strand bent and shaped to define the first attachment means, and a second end of the wire strand bent out of plane relative to the first attachment means in order to define the second attachment means.

The attachment may include an elongate shaft connecting the first and second attachment means. Both first and second attachment means may include retaining members extending from the shaft at an angle. The retaining members may be spring biased to aid retention of the retaining member in an operative retaining condition of generally triangular formation. It may also include a generally hook-shaped member arranged on a free end region thereof for engaging the shaft when in the retaining condition.

The retaining member may be configured to clamp the arcuate hook portion of a fishhook in conjunction with the elongate body or shaft in order to attach and hold captive the fishhook within the retaining zone.

### DETAILED DESCRIPTION OF THE INVENTION

The invention is now described by way of example with reference to the accompanying drawings.

In the drawings:

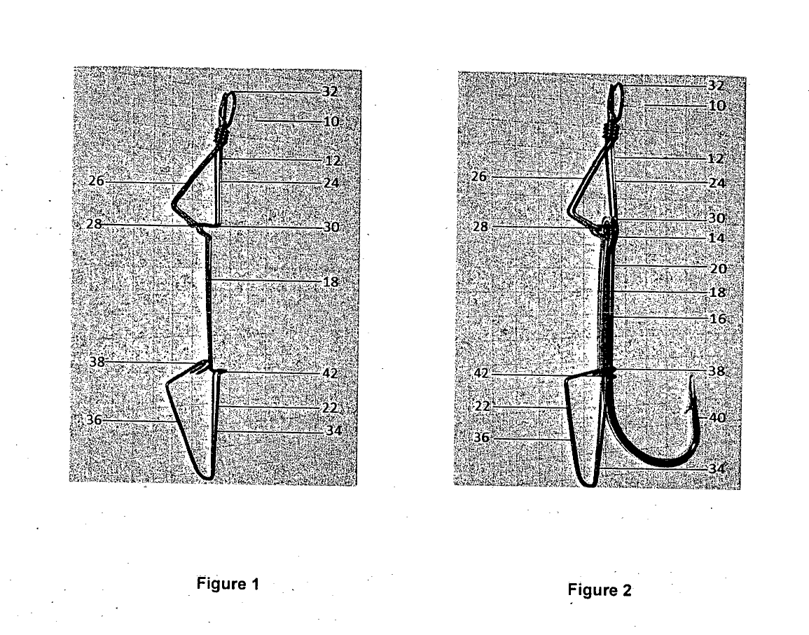

FIG. 1 shows a plan view of a first embodiment of accessory to a fishhook, in accordance with the invention.

FIG. 2 shows a plan view of the first embodiment of the accessory to a fishhook, as seen in FIG. 1, attached to the fishhook.

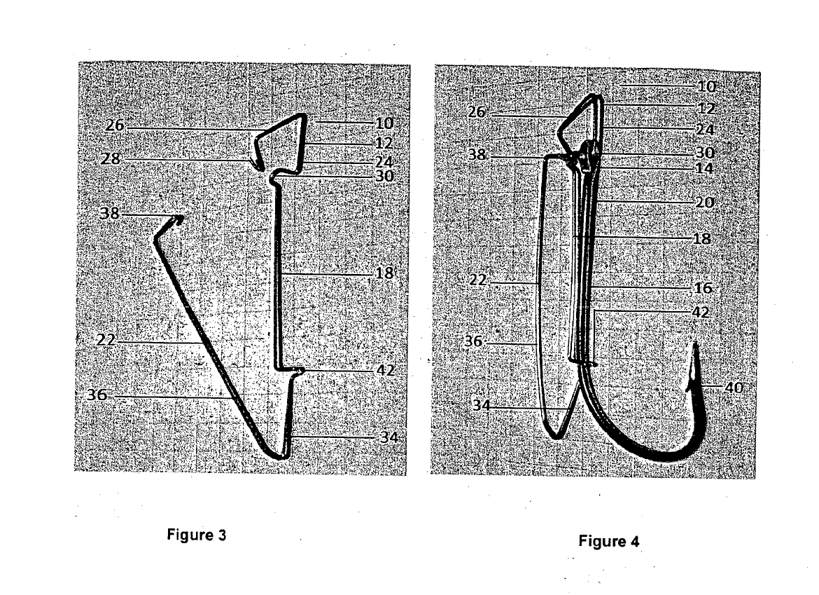

FIG. 3 shows a plan view of a second embodiment of an accessory to a fishhook, in accordance with the invention.

FIG. 4 shows a plan view of the second embodiment of the accessory to a fishhook, as seen in FIG. 3, attached to a fishhook.

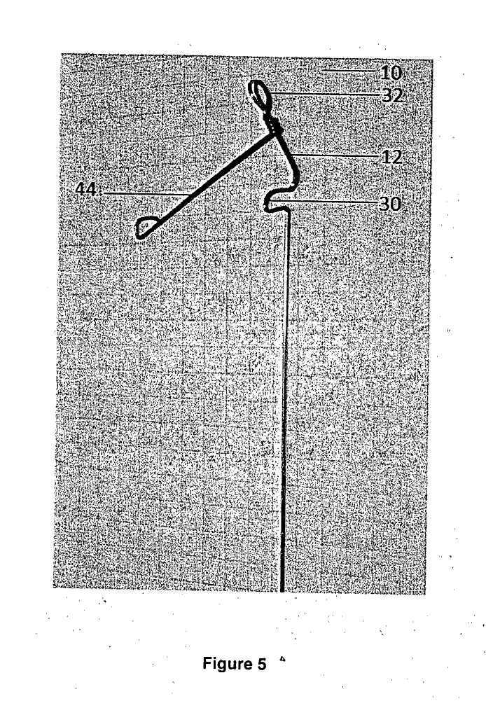

FIG. 5 shows a plan view of a partially formed accessory to a fishhook, in accordance with the invention.

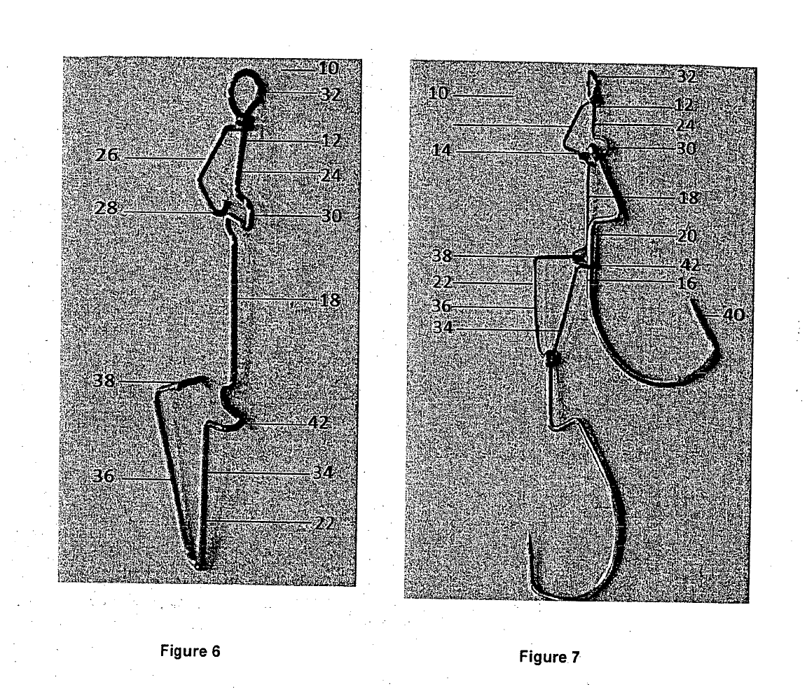

FIG. 6 shows a perspective view of a third embodiment of an accessory to a fishhook, in accordance with the invention.

FIG. 7 shows a perspective view of the third embodiment of the accessory to a fishhook, as seen in FIG. 6, attached to the fishhook.

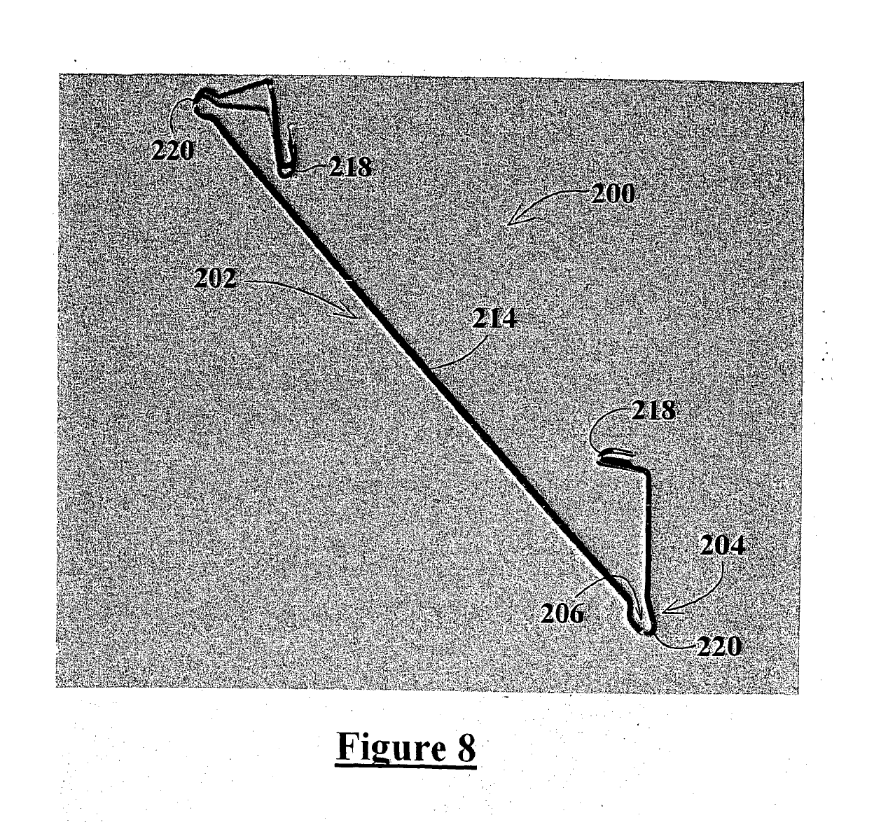

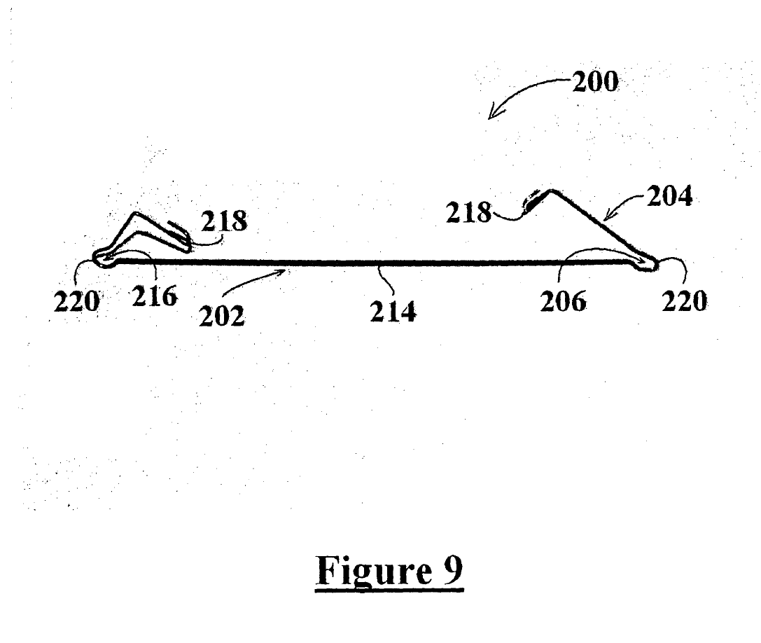

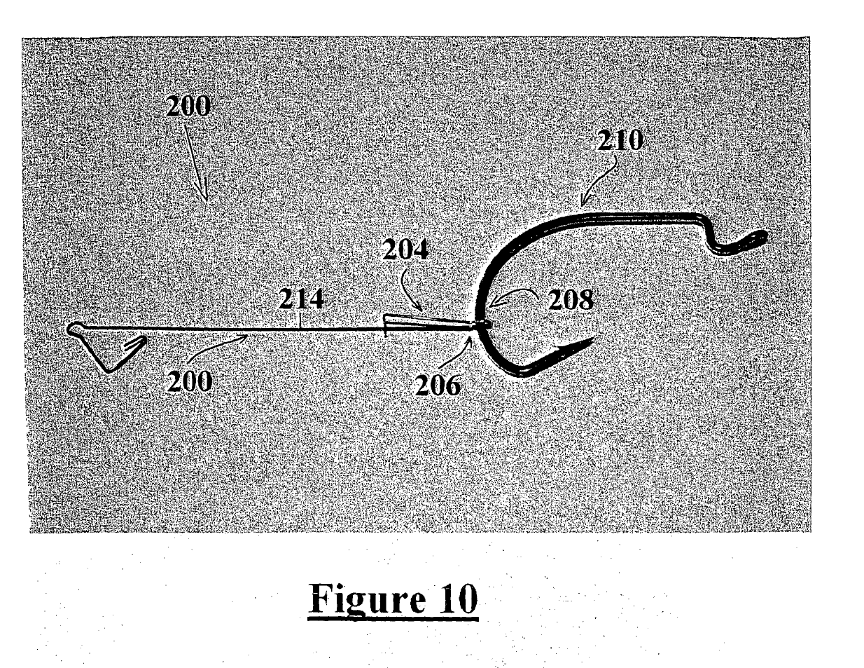

FIGS. 8 to 10 show a perspective view of a further aspect of an accessory to a fishhook.

Referring to the drawings, an accessory to a fishhook, in accordance with all the embodiments of the invention, is generally indicated by reference numeral 10.

As best seen in FIGS. 2 and 4, the accessory to a fishhook 10 includes a positioning means 12 configured to be mounted on an eyelet 14 of the fishhook 16, a connecting means 18 extending from the positioning means 12 which is configured, in use, to be arranged substantially adjacent a shank portion 20 of the fishhook; and an attachment means 22 extending from an opposing end of the connecting means 18 for allowing objects to be attached thereto.

The positioning means 12 includes an elongate first member 24 extending from the connecting means 18 and a retaining member 26 extending from an opposing end of the elongate first member 24 for retaining the elongate first member 24 in a desired position relative to the eyelet 14 in use. The retaining member 26 is spring biased to aid retention thereof in an operative retaining condition of generally triangular formation. The retaining member 26 includes a generally hook-shaped member 28 arranged on a free end region thereof.

A holding means 30 is provided between the elongate first member 24 and the connecting means 18 to permit hooking engagement with the hook-shaped member 28, and further to facilitate retention of the eyelet 14 of the fishhook in use. The holding means 30 in FIGS. 6 and 7 is generally S-shaped consisting of two arcuate extensions.

An eyelet 32 is arranged on a junction between the elongate first member 24 and the retaining member 26 as best seen in FIGS. 1 and 2.

The connecting means 18 is of generally elongate form and the length thereof conforms generally with a shank portion 20 of the fishhook 16.

The attachment means 22 includes an elongate first member 34 extending from the connecting means 18 and a retaining member 36 extending from the opposing end of the elongate first member 34 for retaining objects attached to an elbow defined by the elongate first member 34 and the retaining member 36. The retaining member 36 is spring biased to aid retention thereof in an operative retaining condition.

The retaining member 36 includes a generally hook-shaped member 38 arranged on a free end region thereof. The generally hook-shaped member 38 is configured to engage with a shank portion 20 or hook portion 40 of the fishhook in use (FIGS. 1 and 2). The generally hook-shaped member 38 is configured to engage with the holding means 30 (FIGS. 3 and 4).

A securing means 42 is provided between the elongate first member 34 of the attachment means 22 and the connecting means 18 to permit hooking engagement with the hook-shaped member 38 and to secure the attachment means 22 on the shank portion 20 opposite the hook portion 40 in use (FIGS. 6 and 7). The securing 42 means is generally S-shaped consisting of two arcuate extensions.

FIG. 5 shows that an arm 44 added to the different embodiments which extends from a junction between the elongate first member 24 and the retaining member 26 of the positioning means 12 which allows for objects to be attached thereto in use.

FIGS. 8 to 10 show an accessory to a fishhook, in accordance with a further aspect of the invention, is generally indicated by reference numeral 200.

The accessory to a fishhook 200 is made from a single wire strand 202 with one end of the wire strand 202 bent to define a first attachment means 204 which in turn is shaped to define a first retaining zone 206. The first attachment means 204 is configured to receive and hold captive an arcuate hook portion 208 of a fishhook 210 within the first retaining zone 206.

An opposing end region of the wire strand 202 is bent to define second attachment means 212 connected to the first attachment means 204 by means of an elongate shaft 214 and shaped to define a second retaining zone 216. The second retaining zone 216 is rotated in plane and fixed relative to the first retaining zone 206 and which second attachment means 212 is configured to receive items to which the accessory 200 and fishhook 210 is attached in use.

Both first and second attachment means 204 and 212 consist of a retaining member that includes a hook for engaging the shaft 214 and an elbow portion 220 which forms the respective receiving zone 206 or 216. The elbow 220 of the first retaining zone 206 is sized to clamp on the arcuate hook portion 208 of the fishhook 210 and therefore has to be specifically sized for each application.

This accessory 200 is particularly for use in bass fishing and in connecting and arranging fishhooks on a bass fishing line.

It shall be understood that the examples are provided for illustrating the invention further and to assist a person skilled in the art with understanding the invention and are not meant to be construed as unduly limiting the reasonable scope of the invention.

1. An accessory to a fishhook which includes:
a positioning means configured to be mounted on an eyelet of the fishhook;
a connecting means extending from the positioning means which is configured, in use, to be arranged substantially adjacent a shank portion of the fishhook; and
an attachment means extending from an opposing end of the connecting means for allowing objects to be attached thereto.

2. An accessory to a fishhook as claimed in claim 1 wherein the positioning means includes an elongate first member extending from the connecting means and a retaining member extending from an opposing end of the elongate first member for retaining the elongate first member in a desired position relative to the eyelet in use.

3. An accessory to a fishhook as claimed in claim 2 wherein the retaining member is spring biased to aid retention of the retaining member in an operative retaining condition of generally triangular formation.

4. An accessory to a fishhook as claimed in either claim 2 or 3 wherein the retaining member includes a generally hook-shaped member arranged on a free end region thereof.

5. An accessory to a fishhook as claimed in claim 4 wherein a holding means is provided between the elongate first member of the positioning means and the connecting means to permit hooking engagement with the hook-shaped member, and further to facilitate retention of the eyelet of the fishhook in use.

6. An accessory to a fishhook as claimed in claim 5 wherein the holding means is generally S-shaped consisting of two arcuate extensions.

7. An accessory to a fishhook as claimed in claim 2 wherein an eyelet is arranged on the junction between the elongate first member and the retaining member.

8. An accessory to a fishhook as claimed in claim 2 which includes an arm which extends from a junction between the elongate first member and the retaining member of the positioning means to allow objects to be attached thereto in use.

9. An accessory to a fishhook as claimed in claim 1 wherein the connecting means is of generally elongate form.

10. An accessory to a fishhook as claimed in claim 9 wherein the length of the connecting means conforms generally with a shank portion of the fishhook.

11. An accessory to a fishhook as claimed in claim 1 wherein the connecting means is shaped to define a notch for engaging with or receiving the shank portion of fishhook in use.

12. An accessory to a fishhook as claimed in claim 1 wherein the attachment means includes an elongate first member extending from the connecting means and a retaining member extending from the opposing end of the elongate first member for retaining objects attached to an elbow defined by the elongate first member and the retaining member.

13. An accessory to a fishhook as claimed in claim 12 wherein the retaining member is spring biased to aid retention thereof in an operative retaining condition.

14. An accessory to a fishhook as claimed in claim 12 wherein the retaining member includes a generally hook-shaped member arranged on a free end region thereof.

15. An accessory to a fishhook as claimed in claim 14 wherein the generally hook-shaped member is configured to engage with a shank portion or hook portion of the fishhook in use.

16. An accessory to a fishhook as claimed in claim 5 wherein the generally hook-shaped member of the attachment means is configured to engage with the holding means.

17. An accessory to a fishhook as claimed claim 10 wherein a securing means is provided between the elongate first member of the attachment means and the connecting means to permit hooking engagement with the hook-shaped member and to secure the attachment means on the shank portion opposite the hook portion in use.

18. An accessory to a fishhook as claimed in claim 17 wherein the securing means is generally S-shaped consisting of two arcuate extensions.

19. An accessory to a fishhook which includes:
first attachment means shaped to define a first retaining zone, which first attachment means is configured to receive and hold captive an arcuate hook portion of a fishhook;
second attachment means shaped to define a second retaining zone, which second attachment means is configured to receive and retain items to be attached in use; and
an extension member configured to extend between and interconnect the first and second attachment means.

20. An accessory to a fishhook as claimed in claim 19 wherein the attachment to a fishhook consists of an elongate member shaped to form the first and second attachment means and the extension member.

21. An accessory to a fishhook as claimed in either claim 20 wherein the elongate member takes the form of a single wire strand.

22. An accessory to a fishhook as claimed in claim 21 wherein a first end of the wire strand is bent and shaped to define the first attachment means, and a second end of the wire strand is bent out of plane relative to the first attachment means in order to define the second attachment means.

23. An accessory to a fishhook as claimed in claim 19 wherein the extension means takes the form of an elongate shaft connecting the first and second attachment means.

24. An accessory to a fishhook as claimed in claim 19 wherein either the first or second attachment means includes a retaining member.

25. An accessory to a fishhook as claimed in claim 24 wherein the retaining member is spring biased to aid retention of the retaining member in an operative retaining condition.

26. An accessory to a fishhook as claimed in claim 25 wherein the operative retaining condition is in a generally triangular formation.

27. An accessory to a fishhook as claimed in claim 24 wherein the retaining member includes a generally hook-shaped member arranged on a free end region thereof.

28. An accessory to a fishhook as claimed in claim 24 wherein the retaining member is configured to clamp the arcuate hook portion of a fishhook in conjunction with the extension means in order to attach and hold captive the fishhook within the retaining zone.
